(19) United States
(12) Patent Application Publication
(10) Pub. No.: US 2009/0054146 A1
(43) Pub. Date: Feb. 26, 2009

(54) CONFIGURABLE SINGLE HANDED VIDEO GAME CONTROLLER

(76) Inventors: Michael Epstein, Palm Beach Gardens, FL (US); Benjamin J. Heckendorn, Verona, WI (US)

Correspondence Address: MALIN HALEY AND DIMAGGIO, PA, 1936 S ANDREWS AVENUE, FORT LAUDERDALE, FL, 33316, US

(21) Appl. No.: 12/197,578

(22) Filed: Aug. 25, 2008

Related U.S. Application Data
(60) Provisional application No. 60/957,476, filed on Aug. 23, 2007.

(51) Int. Cl. A63F 13/02

(52) U.S. Cl. 463/38

(57) ABSTRACT

A video game controller that can be configured using a set of video game control switch modules for single hand usage (left or right). The controller is comprised of a controller housing having a base receptacle containing circuitry and a top enclosure which contains several module slots in which removable video game control switch modules can to be inserted and connected to the game controller circuitry via a parallel bus. The removable video game control switch modules which contain the game controls themselves, such as analog joysticks and triggers, can be inserted into any module slot allowing a game player to arrange the controller as desired and have a high level of customization on a per-game or per-user basis.

### BACKGROUND OF THE INVENTION

1. Description of the Invention

A video game controller that can be configured using a set of modules for either left handed or right handed use and is intended to allow a person with the use of only one arm to take full advantage of the controls of a modern video game controller.

2. Description of the Prior Art

This invention is intended to allow persons with the use of only one arm to take full advantage of the controls of a modern video game controller. Previously, there have not been very many options for those in this need, beyond using a standard controller as best they could. Almost all video game controllers, since the beginning of the industry, have required both hands for gripping the controller and, hence, for operating it. This presents a problem for those with the use of only one hand or arm as they cannot both hold the controller and also reach every button.

This invention first solves the problem of holding the controller as the controller is intended to sit on a person's leg or table thus freeing up all fingers for game play. The controller provides all the possible buttons on one surface, as opposed to several buttons on the side as with most modern video game controllers, allowing the fingers to reach whatever button they need to reach. Finally, the buttons and joysticks can be arranged as desired for best results either in specific games or based off what the user finds most comfortable.

### SUMMARY OF THE INVENTION

A video game controller comprising a controller housing that includes a rigid base receptacle having a plurality of side wall and a bottom surface containing the game controller circuitry and a rigid top cover which attaches to the base receptacle's walls forming an enclosure and which contains six module slots (wells, ports or spaces) on its top surface, each leading to a base connector socket (i.e. 30 position board-to-board connector socket) on the base printed circuit boards located below in the base. The base connector sockets all have identical pin outs providing all possible signals required for game play, such as analog joysticks, shoulder buttons and triggers. These signals are then sent down the parallel bus to the game controller circuitry, also housed in the base receptacle, when the signals are processed and then sent to the gaming console itself, either via a wireless or serial data cable connection. The circuitry will vary depending on which system it is intended for, i.e., PlayStation 2, PlayStation 3 and Xbox 360.

The base receptacle has a concave bottom surface which allows the base to be placed on a person's thigh while playing. In addition, at the bottom edges of the base receptacle are flat portions which also allow the controller housing to be placed on a table or other flat surface while playing. For added comfort, a small section of padded material is mounted on the top of the controller housing for a person's palm to rest on.

The invention includes a series of modules that each contain a specific video game electronic control switch that represents each manually actuated function of a standard gaming controller including, but not limited to, the left or right analog joystick, shoulder buttons and the 4 main triggers. At the base of each module is a module connector socket (i.e. 30 position board-to-board connector socket) which mates to any base connector socket. When the module connector socket is mated with any one base connector socket, only the video game control signals required for the specific function of that module's video game electronic control switches are connected to the base connector socket. Thus, when a specific module is plugged into any of the module slots in the controller housing, its function will remain the same. This allows for allowing easy configuration that can be done very quickly. By using a parallel bus and the omission of certain pins on the module connector sockets as the “key,” this alleviates the need for integrated circuits in each module itself, as would be the case with a serial bus system.

The modules have flanges on either side that allow them to be easily gripped for removal as well as molded pieces of plastic on one side that serves as a “key,” by fitting only into a matching tabbed recess in any one of the module slots to ensure proper insertion and orientation of the module.

It is an object of this invention to provide a video game controller that can be configured using a set of modules for single handed use (either left handed or right handed).

It is another object of this invention to provide a video game controller that when configured using a set of modules contain several sockets connected to the game controller circuitry and several removable modules which contain the game controls that can be arranged as desired for a high level of customization per game.

In accordance with these and other objects which will become apparent hereinafter, the instant invention will now be described with particular reference to the accompanying drawings.

### BRIEF DESCRIPTION OF THE DRAWINGS

FIG. 1 shows a top plan view of the video game controller.

FIG. 2 is a front elevational view thereof.

FIG. 3 is a top plan view of the base receptacle with the top cover removed showing the arrangement of internal parts.

FIG. 4 is a front cross sectional, exploded, elevational view of the controller housing top panel and base receptacle showing the arrangement of internal parts.

FIG. 5 is a cross sectional phantom elevational internal view of the analog shoulder trigger module.

FIG. 6 is a cross sectional internal phantom elevational view of the analog shoulder trigger module.

FIG. 7 is a front elevational view of the analog shoulder trigger module.

FIG. 8 is a top plan phantom view of the analog shoulder trigger module.

FIG. 9 is a top plan view of the analog shoulder trigger module.

FIG. 10 is a cross sectional side phantom elevational view of the directional pad module.

FIG. 11 is a front elevational view of the directional pad module.

FIG. 12 is a top plan phantom view of the directional pad module.

FIG. 13 is a top plan view of the directional pad module.

FIG. 14 is a side cross sectional phantom elevational view of the analog joystick module.

FIG. 15 is a front elevational view of the analog joystick module.

FIG. 16 is a top phantom cross sectional plan view of the analog joystick module.

FIG. 17 is a top plan view of the analog joystick module.

FIG. 18 is a side cross sectional phantom elevational view of the 4 button module.

FIG. 19 is a front elevational view of the 4 button module.

FIG. 20 is a top cross sectional phantom plan view of the 4 button module.

FIG. 21 is a top plan view of the 4 button module.

FIG. 22 is a top plan view of the controller being used by a left hand.

### DETAILED DESCRIPTION OF THE PREFERRED EMBODIMENT

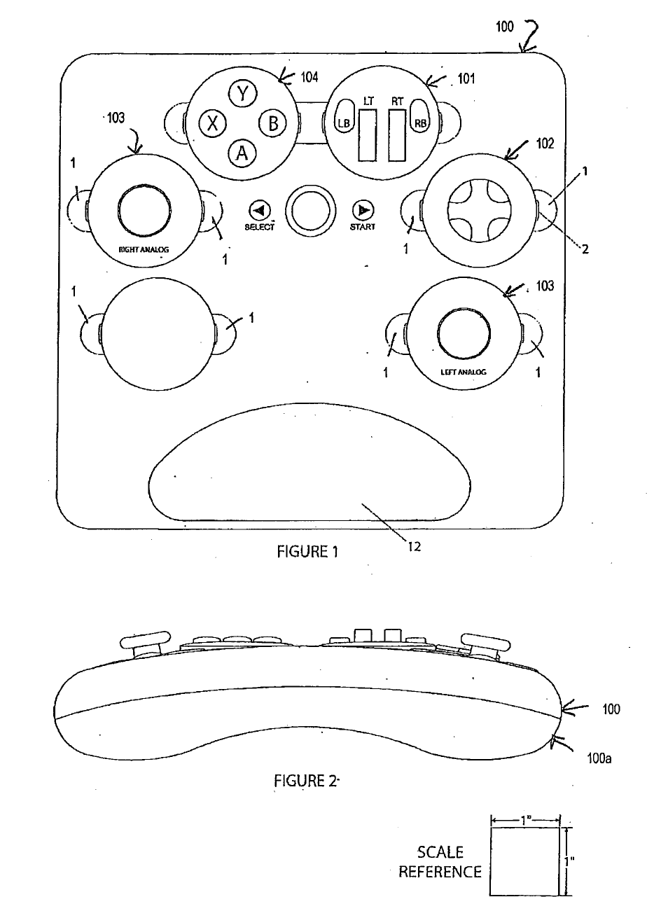

Referring to FIG. 1 of the drawings, the top cover 100 of the controller housing has six module slots that receive different removable and reconfigurable modules such as the analog shoulder trigger module 101, the directional pad module 102, the left analog joystick module 103, the right analog joystick module 103 and the four button module 104. The top cover 100 is shown including the modules 100-104 “installed” in a default arrangement.

Radially extended recesses 1 in the top cover 100 allow the user's fingers to get an easy grip on the side of any installed module and pull the module using the flanges on the side of each module 2. The user's palm can rest comfortably on the padded cushion 12.

A few buttons are built into the top cover 100. These buttons are typically, but not limited to, a “Select/Back” button 14, a “Start” button 17, and a “Guide” button 15, the latter of which returns a user to a menu system as determined by the console. An LED light 16 is located around the perimeter of the “Guide” button 15.

Referring to FIG. 2, the controller housing includes top cover 100 and base receptacle 100a which are made of rigid plastic. The top panel 100 that is attached to the base receptacle 100a forms the entire controller housing.

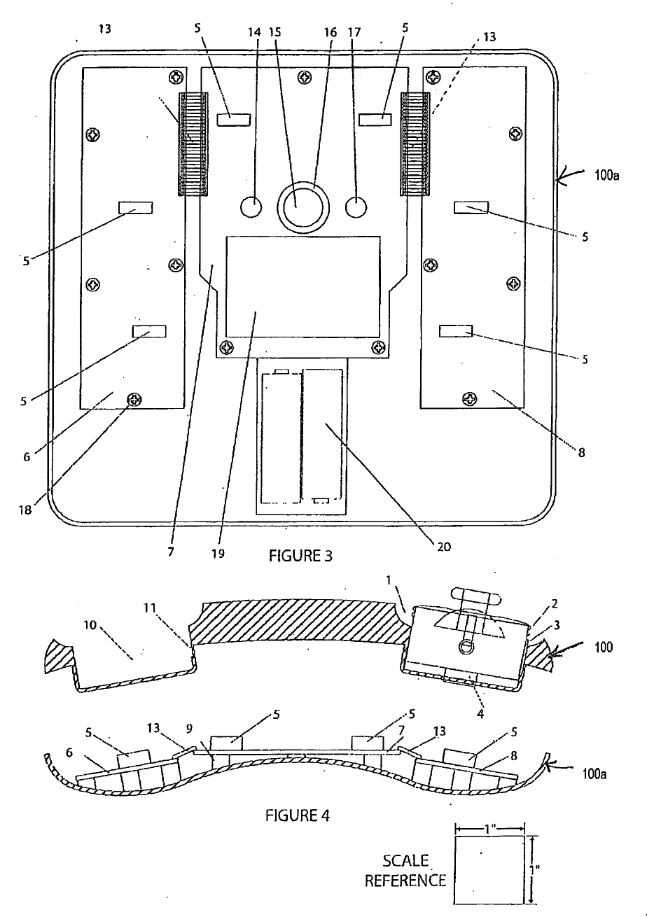

Referring to FIG. 3, the internal view of base receptacle 100a is shown. The base connector sockets 5 receive the module connector sockets 4 when the module is inserted into a module slot 10 and electrically connects the modules to the printed circuit boards 6, 7, 8 and parallel bus. The base connector sockets 5 are arranged in a symmetrical pattern which represents the finger range of an average human hand, the thumb typically being on either of the lowest modules depending on left or right handed use. The “Select/Back” button 14, “Start” button 17, “Guide” button 15, and the LED light around the “Guide” button 16 directly connect to the center printed circuit board 7.

Mounted within the controller base 100a are three (3) printed circuit boards, a left printed circuit board 6, a center printed circuit board 7, and a right printed circuit board 8. Three (3) printed circuit boards are used, instead of only one, so that the outermost boards can be angled to match the curvature of the top of the controller as seen in FIG. 2. The printed circuit boards are mounted to the bottom of the base receptacle 100a via screws 18. The parallel bus signals are transferred from the left and right printed circuit boards to the center one by use of short ribbon cables 13. These parallel bus signals are then transmitted to the game controller logic circuitry 19. The game controller logic circuitry 19 is either powered by the game console itself, as with a serial data connection such as USB, or by a built-in battery pack 20 comprising two double AA batteries or other 3 volt range equivalent.

Referring to FIG. 4, the housing is comprised of base receptacle 100a and top panel 100 that are fastened together. Molded mounting posts 9 are the structures in which the printed circuit boards are mounted on at the bottom of the base receptacle 100a. As seen in an empty module slot 10, there is a recess 11 on one side of the module slot. This tabbed recess 11 is the part that matches a raised portion 3 on each module and becomes the “key” which ensures proper insertion and orientation of the modules. An opening at the bottom of the module slot allows the module connector socket 4 to pass through and mate with the base connector sockets 5 and thus the printed circuit boards 6, 7, 8. The left printed circuit board 6 and the right printed circuit board 8 are shown angled to allow for a curved controller housing.

Common to all modules, the bottom cap of each module is secured in place by screws 30 and contains an empty space 38 that allows room for the through-hole leads on components, such as potentiometers and mounting posts, that extend past the bottom of the module printed circuit board 29, 33, 37, 40. A module connector socket 4 is mounted to each module printed circuit board 29, 33, 37, 40, the module printed circuit board 29, 33, 37, 40 being held in place also by screws 30.

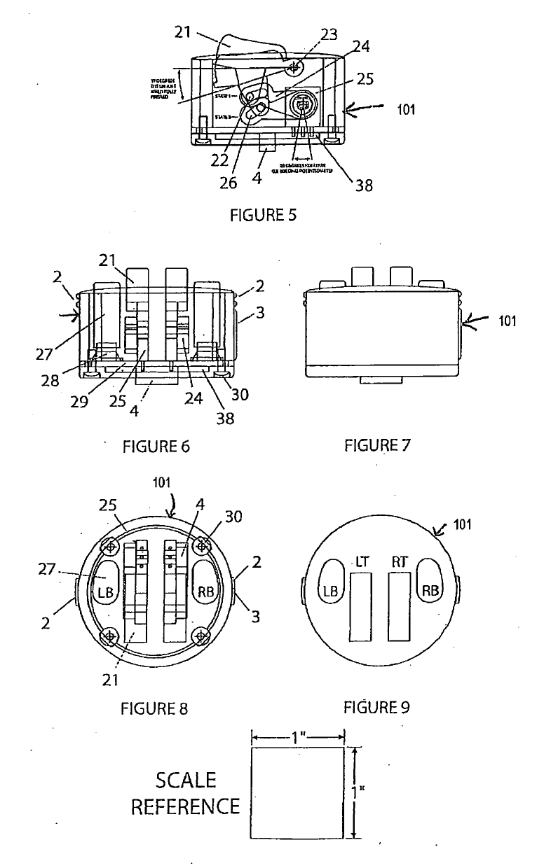

FIG. 5 shows the inside of the analog trigger module 101. This module replicates the buttons typically found on the top side of a gaming controller, usually called the “shoulder buttons” (i.e. L1, L2, R1, R2 or LT, LB, RT, RB). Two of these triggers are analog in function, returning a variable value as to be compatible with a variety of video game platforms. The analog trigger 21, when pressed, rotates on an axis 23, which moves the peg 22 through a gap 26 causing the arm 24 to rotate the wiper of the potentiometer to which it is connected 25.

Referring now to FIGS. 6 and 8, the secondary shoulder buttons 27 are connected to contact dome switches 28 on the analog shoulder trigger module printed circuit board 29, which sends these signals to the module connector socket 4. FIG. 7 and FIG. 9 show the outside of the analog trigger module 101.

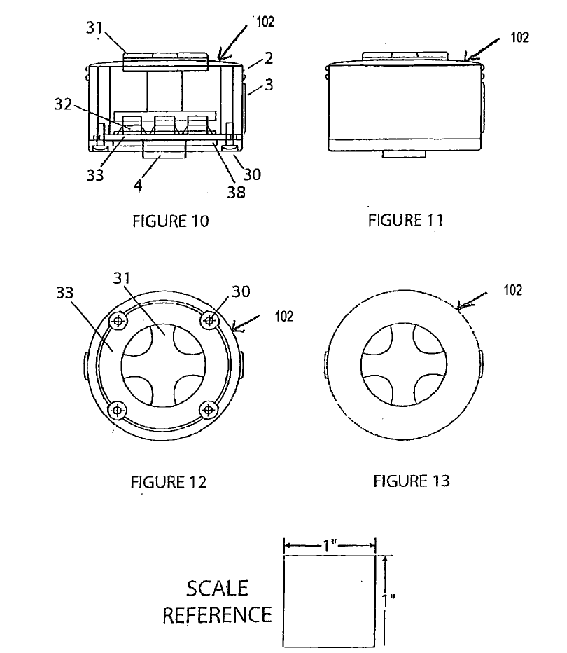

FIG. 10 shows the inside of the directional pad module 102. The eight-way directional pad itself is actuated by the top portion 31, which transfers the motion via a stalk leading down to the contact dome switches 32. These switches are connected to the directional pad module printed circuit board 33, which sends these signals to the module connector socket 4. FIGS. 11, 12 and 13 show the outside configuration of directional pad module 102.

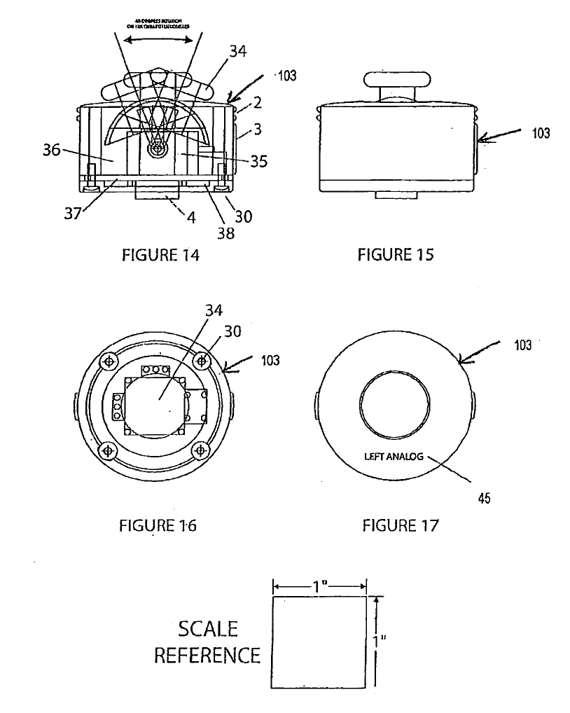

FIG. 14 shows the insides of the analog joystick module 103, of which there are two, the left analog stick and the right analog stick. Both are identical except for labeling 45 which identifies them and the manner in which the signals are connected to the socket 4. As a result, their pin outs are different and their outputs will differ.

In FIGS. 14 and 16, the top of the analog joystick module 103 is a plastic piece 34 with some texturing to allow a better grip for the user's finger. This connects to element 35 of the analog joystick module 103 which interprets all movement via a pair of potentiometers which are connected to the analog joystick module printed circuit board 37. Also contained in the analog joystick module 103 is a press-down contact switch 36, typically referred to as L3 or R3 (for left or right stick) that is connected to the printed circuit board 37 as well. All signals are then sent to the module connector socket 4. FIGS. 15 and 17 show the outside configuration of the analog joystick module 103.

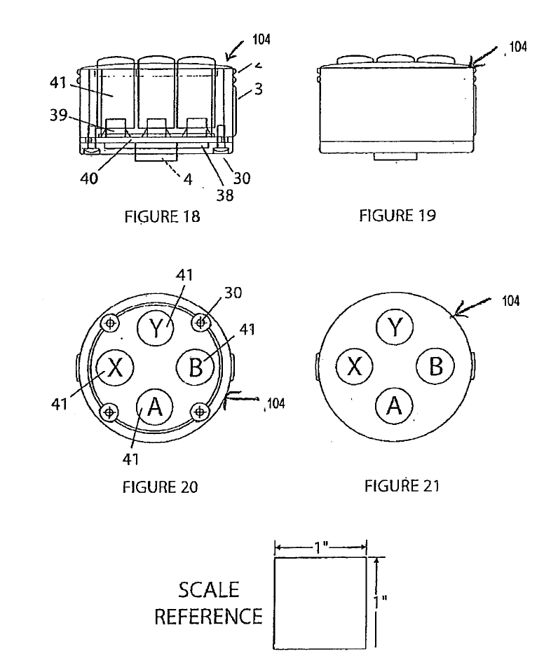

FIGS. 18 and 20 show the insides of the four (4) button module 104. The plastic buttons 41 press down on contact dome switches 39. These switches are connected to the four (4) button module printed circuit board 40, which sends these signals to the module connector socket 4. Labeling of the buttons 41 will vary depending on which console the controller is intended for. “A B X Y” is given as an example. FIGS. 19 and 21 show the outside configuration of 4 button module 104.

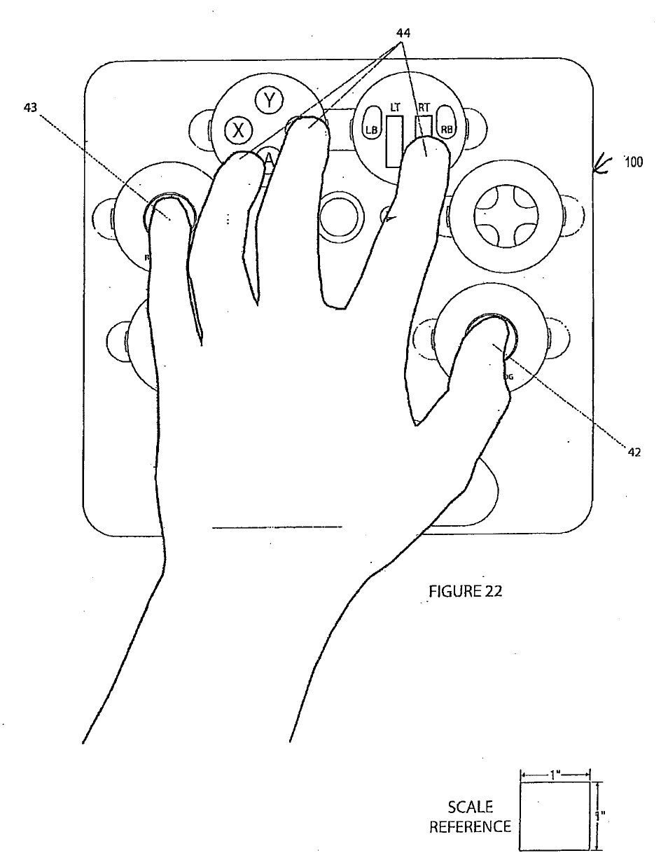

FIG. 22 shows the controller 100 being used by a left handed person. In this configuration, the thumb 42 moves the left analog stick, typically to control the in-game character. The little finger 43 moves the right analog stick, typically to control the in-game camera. The remainder of the fingers 44 are free to press the action buttons and triggers required in the game. For use with the right hand, the modules can be moved around and this setup mirrored horizontally or however the user sees fit. The modules can be swapped out on the fly.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A video game controller for operation by a single hand, left or right, that includes video game electronic control switches mounted in modules, said video game controller including module slots such that the modules can be positioned and repositioned on the top surface of the game board controller allowing swapping of the location of control switches on the fly comprising:
a controller housing for containing the game controller logic circuitry and printed circuit board components that transmit video game control signals, said controller housing including a rigid base receptacle having a plurality of side walls and a bottom surface and a top cover that includes a rigid top surface which engages the base side walls of the base receptacle forming an enclosure for housing the electrical components of the video game controller;
said top cover surface including one or more module slots, each module slot having a pre-determined standard dimensional size, each of said module slot including a base connector socket in the bottom of said module slot;
one or more video game electronic control switches each housed in a standard sized module, each video game electronic control switch providing video game control signals for said video game controller, each module body sized to fit within a said module slot, each of said video game electronic control switches connected to a module printed circuit board that has a module connector socket mounted to said module printed circuit board that connects to the base connector socket in a module slot to establish an electronic connection to the game controller logic circuitry mounted in said controller housing; and
each of said modules being interchangeable between adjacent module slots, said module slots disposed in said controller housing within a predetermined distance from each other allowing all of the digits on a single hand to engage each of the modules for operation of the video game by a single hand.

2. A video game controller as in claim 1, wherein:
the bottom surface of said controller housing is concavely shaped so that a portion of the exterior bottom surface of said housing can fit comfortably against the thigh of a user for positioning the video game controller on one's leg.

3. A video game controller as in claim 1, wherein:
said modules slots each include a pair of radially extended recesses for easily grasping and pulling up said modules from said module slots, said module slots include a tabbed recess that engage corresponding tabs on said module walls for removably securing said module in place in said module slot.

4. A video game controller as in claim 1, wherein:
one of said electronic video game control switches includes an analog joy stick mounted in said module body; and
one of said electronic switches includes an analog trigger.

5. A video game controller as in claim 1, wherein:
one of said electronic switches includes a left analog joy stick; and
one of said electronic switches includes a light analog joy stick.

6. A video game controller as in claim 1, wherein:
each of said module bodies are substantially cylindrical in shape and include flanges strategically disposed near the upper surface, with one on each side, for grasping purposes for removing said module body from a module well manually.

7. A video game controller as in claim 1, wherein:
said modules include at least a four button module, at least one analog joy stick module, and at least one directional pad module.

8. A reconfigurable video game controller wherein all possible input interfaces are located on one surface and positioned to be accessed by a single hand, with said reconfigurable video game controller comprising:
a rigid controller housing comprising a base receptacle containing a left printed circuit board, a center printed circuit board, and a right printed circuit board, each with one or more base connector sockets, and a top cover containing one or more static buttons and a number of module slots equal to the number of base connector sockets, with said base receptacle is fastened to said top cover;
one or more individual modules each having a manually actuated video game electronic control switch and that contain a module printed circuit board with a module connector socket connected to said module printed circuit board; and
each module mountable in each module slot and each module slot spaced relative to each other to allow manual switch actuation with a single hand.

9. The reconfigurable video game controller of claim 8, wherein the base receptacle has a concave bottom with flat portions at the edges of said base receptacle, said flat portions for resting on a flat surface.

10. The reconfigurable video game controller of claim 8, wherein:
said left printed circuit board, center printed circuit board, and right printed circuit board are mounted securely the base receptacle;
the location of any one base connector socket corresponds to the location of any one module slot;
each base connector socket can receive signals required to operate any function that any specific module can perform;
the left printed circuit board and the right printed circuit board are electronically connected to the center printed circuit board by short ribbon cables;
said top cover being convexly curved for the human hand;
the left printed circuit board and the right printed circuit board are angled to match the curvature of the top cover; and
a game controller logic circuitry being housed on the center printed circuit board and communicating with said video game console.

11. The reconfigurable video game controller of claim 8, wherein electrical power for said game controller logic circuitry is generated remotely by the video game console and transferred by a wired connection.

12. The reconfigurable video game controller of claim 8, wherein electrical power for said game controller logic circuitry is generated within the video game controller by a battery and connected directly to the center printed circuit board.

13. The reconfigurable video game controller of claim 8, wherein the top panel
has a section padded material; and
has recesses around each module slot to receive fingers.

14. The reconfigurable video game controller of claim 8, wherein each module slot has a portion on one side that is recessed.

15. The reconfigurable video game controller of claim 8, wherein each module can perform a specified function.

16. The reconfigurable video game controller of claim 8, wherein the module connector socket can mate with any one of the base connector sockets when said module is inserted into the module slot corresponding with the base connector socket

17. The reconfigurable video game controller of claim 8, wherein the body of each module:
contains ridges on either side;
includes a bottom cap secured by a cap fasteners and said module printed circuit board is held in place by said cap fasteners; and
has a raised portion that will correspond to the recessed portion of a module slot when the module is plugged into one of the module sots in the proper orientation.

18. The reconfigurable video game controller of claim 8, wherein the module connector socket found on each module can only send signals required to perform that module's function.
